(19) United States
(12) Patent Application Publication
(10) Pub. No.: US 2007/0009668 A1
(43) Pub. Date: Jan. 11, 2007

(54) Microencapsulation of particles in a polymer solution by selective withdrawal through a high viscosity low density fluid and subsequent crosslinking

(76) Inventors: Jason Lloyd Wyman, Chicago, IL (US); Marc Rider Garfinkel, Chicago, IL (US); Sidney Robert Nagel, Chicago, IL (US); Milan Mrksich, Chicago, IL (US); William Shannon Dillmore, Cork (IE)

Correspondence Address: BRINKS HOFER GILSON & LIONE, P.O. BOX 10395, CHICAGO, IL, 60610, US

(21) Appl. No.: 10/992,615

(22) Filed: Nov. 18, 2004

(51) Int. Cl. B05D 1/18; B05C 3/00

(52) U.S. Cl. 427/430.1; 427/212; 118/400; 118/429

(57) ABSTRACT

The invention provides methods and apparatus for encapsulating particles. An inverted selective withdrawal technique is employed. Two immiscible fluids are added to a container, a first fluid is an aqueous pre-polymer solution with a crosslinking reagent and a second fluid is denser highly viscous fluid. A selective withdrawal tube pulls particles suspended in the first fluid through the second fluid. The particles retain a thin coating of the first fluid. The coated particles are then subjected to a crosslinking process where the pre-polymer solution of the first fluid surrounding the particles is converted into a hydrogel capsule.

### BACKGROUND OF THE INVENTION

The present invention relates to a method and apparatus for encapsulating particles. More particularly the invention relates to methods and apparatus for encapsulating particles with a coating that substantially conforms to the size and shape of the individual particles utilizing selective withdrawal technology. The technique and apparatus described and claimed herein may be beneficially employed for encapsulating biological materials such as islets of Langerhans for transplantation as a treatment for Type I Diabetes.

When two fluids of different densities are added to a container the less dense fluid floats to the top of the container, floating above denser fluid which sinks to the bottom. An interface boundary is formed between the two fluids. Selective withdrawal technology involves the “selective” withdrawal of one or portions of both fluids from the container.

A tube may be inserted into the upper fluid to pump fluid from the container. A pump connected to the tube creates suction at the inlet to the tube, drawing fluid into the tube. At low suction levels, a slow flow of the less dense upper fluid layer enters the nozzle of the tube. The denser fluid remains in the container. However if the suction is strong enough, and the inlet to the tube is close enough to the interface, the interface will begin to deform upwardly, forming a small rise in the area below the nozzle. When the suction level is sufficiently increased, the rise becomes unstable and forms a spout at the interface of the two fluids. The spout is formed of the heavier, lower fluid, which is entrained within the lighter, upper fluid flowing up into the tube. The diameter of the spout decreases substantially from its base toward the tube orifice. Further increasing the suction level or decreasing the distance between the orifice and the interface widens the spout. Once inside the tube, the spout breaks up into small droplets.

A method for encapsulating particles using selective withdrawal techniques is disclosed in U.S. Pat. No. 6,558,665, (the '665 Patent) the entire disclosure of which is incorporated herein by reference. FIG. 1 of the present specification illustrates a time sequence of the process of coating a poppy seed using the method disclosed in the '665 patent. The particle, in this case is a poppy seed, is suspended in the denser lower fluid 14. A selective withdrawal tube 18 is placed in the container with a fluid inlet located in the upper fluid 12 above and facing the fluid interface 16. Fluid is pumped from the container through the selective withdrawal tube creating suction at the inlet to the selective withdrawal tube. The suction draws both fluids 12, 14 toward the tube 18 (FIG. 1A). The fluid flowing into the tube is predominantly the less dense upper fluid 12. However, the denser lower fluid 14 bulges upward toward the withdrawal tube 18 until a narrow spout 20 of the heavier second fluid 14 is pulled into the tube 18. The fluid flowing into the spout carries the particle 22 into the spout (FIG. 1B), and the suction at the inlet to the tube 18 pulls the particle up into the tube 18.

Eventually the spout collapses above and below the particle (FIG. 1C), leaving the particle surrounded by a thin layer of the heavier lower fluid 14 suspended within the less dense upper fluid 12. Surface tensions within the thin coating surrounding the particle 22 eventually distribute the thin layer of the heavier lower fluid 14 evenly around the particle leaving a thin uniform coat around the particle. According to the '655 patent, the lower heavier fluid 14 may comprise a prepolymer fluid which may then be polymerized and crosslinked to form a hard coating. The '655 patent further teaches crosslinking a poly (ethylene glycol) (PEG) coating by exposing the coated particle to ultraviolet light. Other biocompatible polymers are also described.

It is also known that the selective withdrawal geometry described in the '655 patent may be inverted by inserting the selective withdrawal tube up through the bottom of the container. In this case, the inlet is positioned just below the fluid interface. In this arrangement the denser aqueous fluid 14 becomes the primary fluid drawn through the selective withdrawal tube. The spout forms in the lighter upper fluid 12 and extends downward toward the tube. Such an inversion allows hydrophobic particles to be coated in oil soluble reagents.

### SUMMARY OF THE INVENTION

The present invention relates to methods and apparatus for coating particles. The methods and apparatus are particularly well suited for encapsulating particles whose density is greater than that of the fluid within which the particle is to be coated with a semi-permeable membrane which will allow the diffusion of smaller molecules such as glucose and insulin while excluding larger molecules such as antibodies. The particles may be islets of Langerhans. When encapsulated in this manner islets have shown viable production of insulin in response to glucose stimulation comparable to the insulin response of unencapsulated islets. Therefore, it is hoped that islets of Langerhans encapsulated according to the methods and apparatus described herein may be transplanted into humans without requiring significant immuno-suppression as a treatment for Type I diabetes.

A method for coating particles according to the invention employs selective withdrawal techniques. The method employs the inverted geometry wherein two immiscible fluids are added to a container. Particles are suspended in the first fluid which is less dense and floats atop the second fluid. The second fluid has significantly higher viscosity than the first fluid. A selective withdrawal tube is placed in the container with an inlet port below and facing the interface between the two fluids. As fluid is drawn out of the selective withdrawal tube, the interface between the two fluids is deformed to the point where a downward directed spout containing the first upper fluid flows into the selective withdrawal tube. The spout is completely entrained within the second lower fluid which also flows into the selective withdrawal tube. The first fluid carries individual particles into the spout. As the spout is drawn further into the selective withdrawal tube it eventually collapses above and below the particles, leaving a thin coating of the first fluid surrounding the particles.

The first fluid may be an aqueous pre-polymer solution such as poly(ethlene glycol) diacrylate (PEG) with a photo-sensitive crosslinking/reagent such as eosin-y. When coated with such a solution, the particles may be exposed to a green light source such as the 488 nm and 516 nm lines of an argon ionlaser to initiate a crosslinking reaction to form a hydrogel coating around the particles.

An apparatus according to the invention for implementing the particle coating process includes a container for holding the two immiscible fluids, a selective withdrawal tube, and a pump for pulling the coated particles through the second fluid into the selective withdrawal tube and into a crosslinking chamber. The crosslinking reaction is initiated within the crosslinking chamber by, for example, shining a light source on the particles as they traverse the crosslinking chamber. Other known methods of initiating a crosslinking polymerization process may be employed in the alternative. The apparatus further includes a particle collection container where coated particles are stored, at least temporarily, after the crosslinking process is complete. Coated particles may be harvested by a filter disposed within the particle collection container, or the fluid containing the coated particles may be pumped into a separate storage vessel, from which the encapsulated particles may be later recovered by filtration or other means.

Employing the methods and apparatus of the present invention, particles may be efficiently coated with high quality uniform coatings wherein the thickness of the coating is substantially independent of the size of the particle. The invention increases production rates of coated particles and improves the quality of the coatings. Islets of Langerhans have been successfully coated using the invention. Experiments have shown that islets encapsulated according to the invention demonstrate an insulin response to glucose that is almost indistinguishable from unencapsulated islets. Further, the encapsulated islets have demonstrated the ability to exclude fluorescently labeled lectin molecules having a molecular weight of 140 kDa. Accordingly, encapsulating islets according to the present invention appears to be a promising technique for immuno-isolation.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the appended claims.

### BRIEF DESCRIPTION OF SEVERAL VIEWS OF THE DRAWINGS

FIGS. 1A, 1B and 1C show a particle being coated according to a prior art selective withdrawal coating technique.

FIG. 2 shows an inverted selective withdrawal particle coating technique.

FIG. 3 shows a schematic view of an apparatus for coating particles.

FIG. 4 shows a schematic view of an apparatus for coating particles, in a particle production mode.

FIG. 5 shows a schematic view of an apparatus for coating particles, in a particle collection mode.

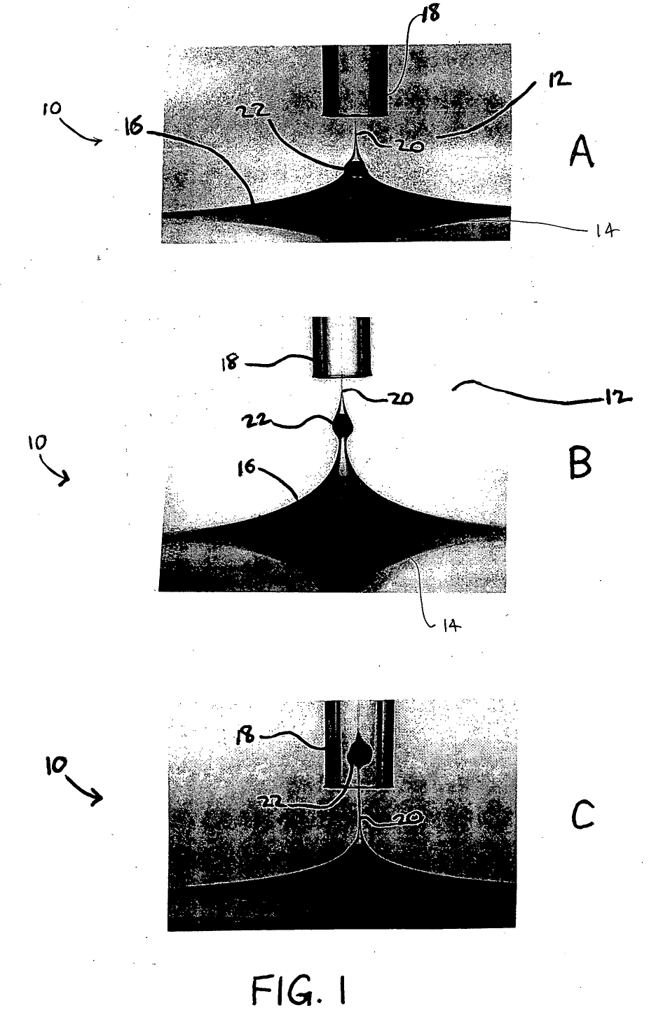

### DETAILED DESCRIPTION OF THE INVENTION

The present invention relates to methods and apparatus for coating particles. The coated particles may be Islets of Langerhans for transplantation into a patent for treating Type I diabetes. Preferably Islets of Langerhans are encapsulated in crosslinked poly (ethylene glycol) diacrylate (PEG) to form a hydrogel capsule surrounding the Islets. Ideally such a coating will provide a semipermiable membrane which allows for the free diffusion of relatively smaller molecules such as insulin and glucose while excluding larger molecules such as antibodies.

The invention employs the selective withdrawal technique to individually coat particles. This technique provides for the complete encapsulation of particles in a protective coating of controlled thickness independent of the size of the particle. The invention employs the inverted geometry described above. First and second immiscible fluids are added to a container. The first fluid is less dense than the second fluid and floats to the top of the container, forming an interface between the two fluids. The particles to be coated are suspended in the first fluid. The particles themselves are denser than the first upper fluid, but not as dense as the second lower fluid. Accordingly, the particles remain in the first upper fluid, but tend to sink to the bottom of the upper fluid, congregating at the interface between the two fluids. A fluid withdrawal tube is provided to pull particles coated with the first upper fluid through the second fluid and into the tube.

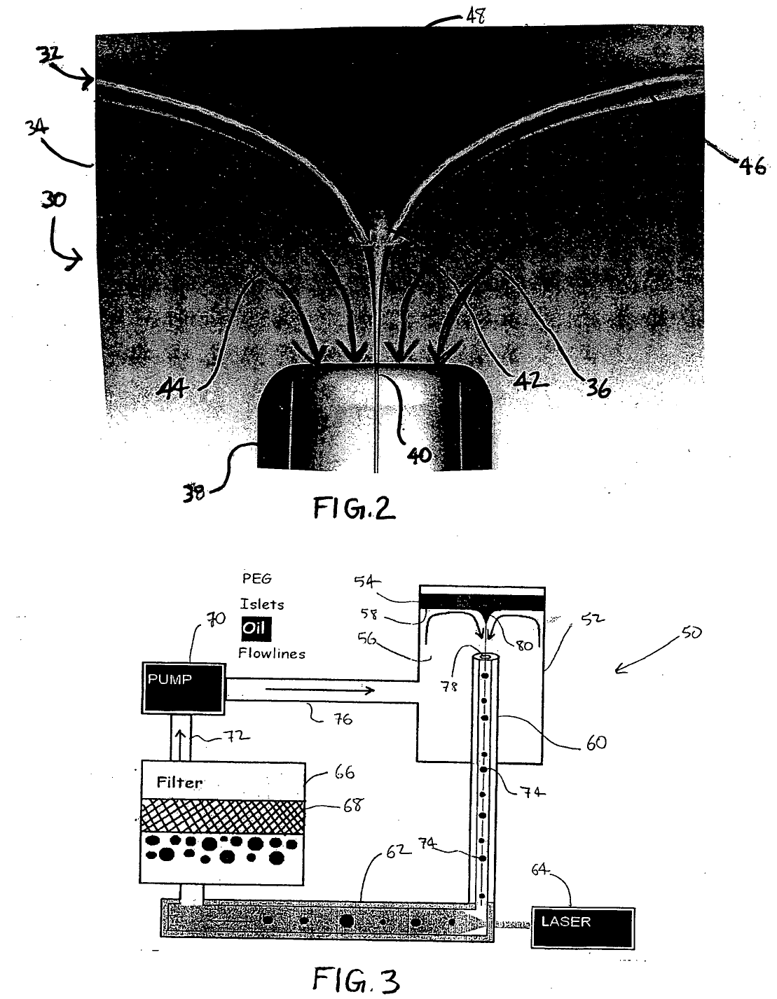

FIG. 2 shows the inverted geometry of a selective withdrawal particle coating system 30. A first immiscible fluid 32 floats above a second immiscible fluid 34, forming an interface boundary 36 therebetween. The two fluids 32, 34 are drawn downward into the selective withdrawal tube 38. The first fluid 32 is drawn into a spout 40 completely entrained within the second fluid 34. A particle 42 which is to be coated by the first fluid 32 is drawn downward within the spout 40. Arrows 44 show the direction of the flow of the second fluid 34 into the selective withdrawal tube 38. Arrows 46 show the direction of flow of the first fluid 32 into the spout 40 and into the selective withdrawal tube 38. Arrows 48 show eddy currents formed in the first fluid flowing away from the spout 40.

Eddy currents in the first fluid near the point where the spout 40 joins the interface form at all flow rates and act to drive particles away from the spout. Particles will enter the spout only if the force exerted on the particles by the eddy currents 48 is less than the force of gravity pulling the particles down into the spout 40. The force exerted by the eddy currents 48 is less at lower flow rates. However, if the flow rate is reduced too much the spout 40 collapses and disappears.

According to past selective withdrawal systems, the first (upper) fluid has been a hydrophobic viscous fluid such as oil, and the lower fluid has been a lower viscosity aqueous solution. The present inventors have learned, however, that by reversing the fluids, placing the aqueous phase above a dense highly viscous lower fluid, it is possible to generate thin stable spouts at significantly lower flow rates. This allows particles to be more readily drawn into the spout, increasing the yield of encapsulated particles. In an embodiment of the invention the first fluid 32 is an aqueous solution of poly (ethylene glycol) diacrylate. The second fluid 34 is Paroil-152 manufactured Dover chemical. Paroil-152 is highly viscous having a viscosity of 1476 centi-stokes. In general it is preferred that the first fluid 32 has a viscosity in the range between 1 I to 50 cSt.

FIG. 3 shows an apparatus 50 according to the present invention for coating particles such as Islets of Langerhans. The apparatus 50 includes a first fluid container or tank 52, a selective fluid withdrawal tube 60, a crosslinking chamber 62, a laser 64, a particle collection tank 66, a filter 68, and a fluid circulating pump 70. First and second immiscible fluids 54 and 56 are added to the first container 52. The less dense first fluid 54 floats above the denser second fluid 56, forming an interface 58 therebetween. The second fluid 56 is a high viscosity fluid such as paroil 152. The particles to be coated are suspended in the first fluid 54. The inlet 78 to the selective fluid withdrawal tube 60 is positioned in the first container 52 below the interface 58. The pump 70 circulates fluid through the system, drawing fluid into the selective fluid withdrawal tube 60, through the crosslinking chamber 62, and through the particle collection tank 66. Pump inlet tube 72 connects the particle collection tank 66 to the pump 70.

The pump discharges fluid back to the first fluid container 52 via return tube 74. In operation the pump 70 creates suction at the inlet 78 of the selective fluid withdrawal tube 60. The suction deforms the interface 58 between the first and second fluids 54, 56, forming the spout 80 as has been described. Particles suspended in the first fluid 54 fall into the spout 80 and are drawn into the selective withdrawal tube 60. The spout 80 eventually collapses above and below the particle due to the Rayleigh instability, leaving individual particles 74 coated with a thin layer of the first fluid 54 suspended within the second fluid 56. The coated particles 74 flow with the second fluid 56 as it is pumped through the system 50.

The first fluid 54, which forms the coating to be applied to the particles 74, is an aqueous solution of non-crosslinked poly (ethylene glycol)(PEG) polymer chains and a photosensitive crosslinking agent (Eosin-y). The coated particles 74 are drawn into the crosslinking chamber 62 where they are exposed to the light output of laser 64. Laser 64 may be an argon ion laser which outputs green 516nm photons. The interaction between the green photons output from the laser 64 and the crosslinking agent Eosin-y initiates the crosslinking process which solidifies the coating surrounding the particles, forming a semipermeable PEG hydrogel barrier around the particle.

Particle exposure to the light output from the laser 64 can be extended by applying a reflective coating to the surfaces of the crosslinking chamber 62 and lengthening the crosslinking chamber 62. The cross-sectional area of the crosslinking chamber may also be increased, to slow the flow rate of the particles 74 through the crosslinking chamber 62. This will further extend the exposure of the particles 74 to the output of the laser 64.

Following exposure to the light output of laser 64, the particles 74 are carried out of the crosslinking chamber 62 and into the collection tank 66. The collection tank 66 includes a removeable filter 68. The filter 68 traps the coated particles 74 as the fluid carrying the particles flows through the collection tank 66. The filtered fluid flows from the collection tank 66 into pump inlet 72 and is discharged back into the first fluid container 52 via return tube 76. The particles 74 may be harvested by stopping the pump 70 to halt the flow of fluid through the system and removing the filter 68.

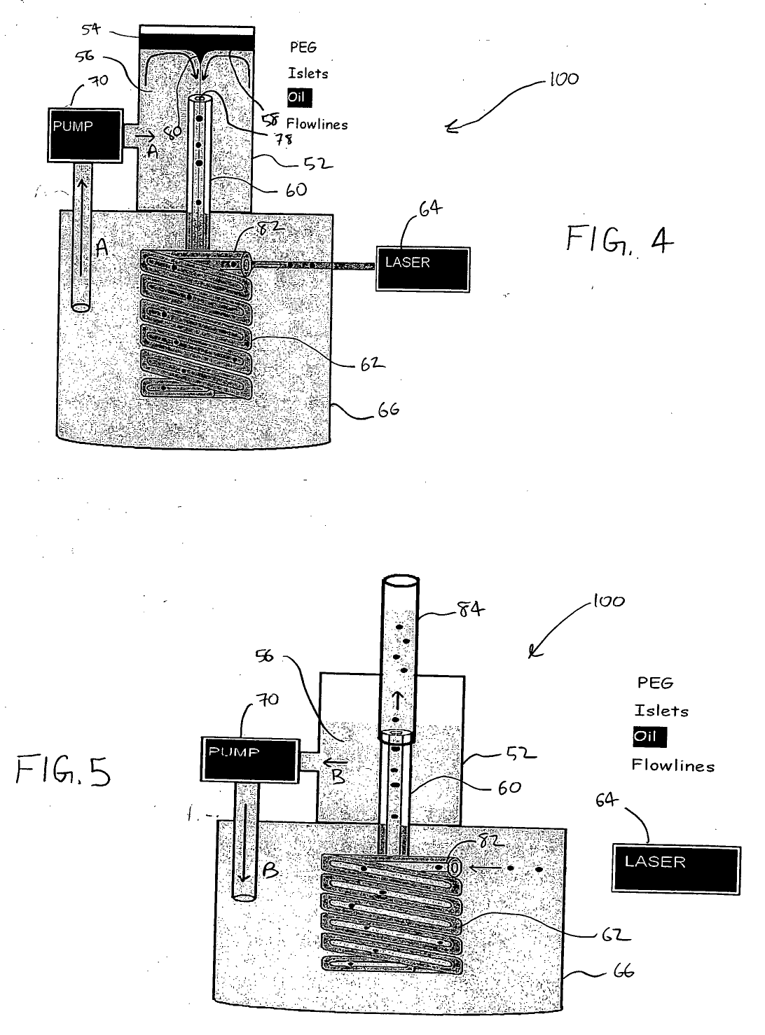

Another embodiment of an apparatus 100 for coating particles such as Islets of Langerhans is shown in FIGS. 4 and 5. The apparatus 100 has many of the same components as the apparatus 50 shown in FIG. 3. Like components will be given like reference numbers. The apparatus 100 includes a first fluid container 52; a selective withdrawal tube 60; a crosslinking chamber 62; a laser 64; a particle collection tank 66; and a pump 70. First and second immiscible fluids 54 and 56 as described above are added to the first container 52. The less dense first fluid 54 floats above the denser second fluid 56 forming an interface 58 therebetween. The particles to be coated are suspended in the first fluid 54.

A primary difference between the apparatus 50 shown in FIG. 3 and the apparatus 100 is that the crosslinking chamber 62 in apparatus 100 is configured as a coiled tube disposed directly within the collection tank 66. Initially fluid is pumped in the direction indicated by the arrows labeled A in FIG. 4. This creates suction at the inlet 78 of the selective withdrawal tube 60, deforming the interface 58 to create the spout 80 and draw particles 74 coated with the first fluid 54 into the selective withdrawal tube 60, all as previously described.

The newly coated particles 74 flow downward into the crosslinking chamber 62 which in this case comprises a long coiled tube. The surfaces of the coiled tube are silvered along the tubes' entire length. The silvered surfaces of the coiled crosslinking chamber provide internal reflection of the light output from laser 64. The laser is positioned such that the output of laser 64 is directed axially directly into the distal end of the crosslinking chamber 62. The silvering of the coil reflects the laser output and ensures that particles 74 are exposed to the light from the laser throughout the entire length of the coil.

Eventually the coated particles flow out of the crosslinking chamber 62 and collect in the collection tank 66. Having been exposed to the laser output for an extended period of time, the crosslinking process is complete and the particles emerge encapsulated in a thin semipermeable PEG hydrogel coating.

The coated particles may be harvested by reversing the flow of pump 70 as shown in FIG. 5. Fluid then flows in the direction indicated by the arrows B. Fluid containing the coated particles flows from the collection tank 66 into the output end 82 of the coiled tube comprising the crosslinking chamber. A particle collecting pipette 84 is placed over what was the inlet 78 of the selective withdrawal tube 60. The reverse flowing fluid flows out of the selective withdrawal tube 60, carrying the coated particles 74 into the collection pipette 84.

In either of the two embodiments described above the harvested coated particles may be further exposed to a light source, such as an incandescent bulb or the like. Further exposure to light continues the hardening process to further strengthen the coating around the particles.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of coating a particle comprising:
placing first and second immiscible fluids in a container, said second fluid being denser than said first fluid such that said first fluid rises above said second fluid, forming a substantially horizontal interface therebetween, said second fluid having substantially higher viscosity than said first fluid;
suspending a particle in said first fluid, the particle having a density greater than the first fluid;
withdrawing fluid from said container through an orifice positioned below and directed toward said interface such that the interface is deformed into a spout with a portion of said first fluid including said particle entrained within a flow of said second fluid into said orifice, and
collapsing the spout above and below the particle

2. The method of claim 1 wherein said first fluid has a viscosity in the range between about 1 cSt and 50 cSt.

3. The method of claim 2 wherein the second fluid has viscosity of about 1476 cSt.

4. The method of claim 2 wherein the second fluid comprises Paroil-152.

5. The method of claim 1 wherein the first fluid comprises an aqueous pre-polymer solution.

6. The method of claim 5 wherein the aqueous pre-polymer solution comprises an aqueous solution of poly(ethylene glycol) diacrylate (PEG).

7. The method of claim 6 wherein the aqueous pre-polymer solution further comprises Eosin-y.

8. The method of claim 7 further comprising exposing particles coated with the aqueous pre-polymer solution to green light in order to initiate a crosslinking reaction to transform the aqueous pre-polymer coating surrounding the particles into a hydrogel coating encapsulating the particle.

9. The method of claim 1 wherein the second fluid comprises Paroil-152 having a viscosity of 1476 cSt, and said first fluid comprises an aqueous pre-polymer solution with a light sensitive crosslinking reagent.

10. The method of claim 9 further comprising exposing particles coated with said aqueous pre-polymer solution to a light source for initiating a crosslinking reaction.

11. The method of claim 10 wherein said aqueous pre-polymer solution comprises poly(ethylene glycol) diacrylate and Eosin-y and said light source comprises an argon ion laser having green light output of 516 nm wavelength.

12. The method of claim 1 further comprising transforming the first fluid coating said particle into a hydrogel coating encapsulating said particle, said hydrogel coating excluding molecules have molecular weight greater than about 140 kDa.

13. The method of claim 12 wherein said particles are islets of Langerhans.

14. An apparatus for coating particles comprising:
a first container for holding first and second immiscible fluids, said fluids forming a substantially horizontal interface boundary within said first container, said second fluid having higher density and higher viscosity than the first fluid, said particles being suspended in the first fluid above the interface boundary;
a selective withdrawal tube communicating with the first container and having an inlet below and directed toward said interface;
a polymer crosslinking chamber communicating with the selective withdrawal tube such that coated particles drawn into the selective withdrawal tube may flow into the polymer crosslinking chamber wherein a polymerization process is initiated to encapsulate said parties;
a particle collection container for collecting coated particles, and
a pump for circulating fluid through the apparatus, the pump generating suction at the inlet to the selective withdrawal tube to draw particles coated with the first fluid through the second fluid and into the selective withdrawal tube, through the crosslinking chamber, and into the particle collection container.

15. The apparatus of claim 14 further comprising a light source for initiating a crosslinking reaction in the second fluid coating the particles when the particles enter the crosslinking chamber.

16. The apparatus of claim 15 wherein the light source comprises an argon ion laser having light output of 516 nm wavelength.

17. The apparatus of claim 15 wherein the crosslinking chamber comprises an elongate tube having a reflective surface.

18. The apparatus of claim 15 wherein the crosslinking chamber comprises a helical coiled tube having a reflective surface suspended within the particle collection container.

19. The apparatus of claim 18 wherein said pump is reversible such that fluid and coated particles suspended therein may be pumped out of the particle collection chamber backward through the crosslinking chamber, out the selective withdrawal tube and into a vessel placed over the inlet to the selective withdrawal tube.

20. The apparatus 14 further comprising a particle collection filter disposed within the particle collection tank, said filter adapted to trap coated particles as fluid is pumped through the particle collection container.
